(19) United States
(12) Patent Application Publication
(10) Pub. No.: US 2025/0134265 A1
(43) Pub. Date: May 1, 2025

(54) MODULAR PORTABLE ENERGY-SAVING PADDED SEAT WARMER

(71) Applicants: Evan KAMAT, St. Louis, MO (US); Hans KAMAT, St. Louis, MO (US); Vinay Gopal KAMAT, St. Louis, MO (US)

(72) Inventors: Evan KAMAT, St. Louis, MO (US); Hans KAMAT, St. Louis, MO (US); Vinay Gopal KAMAT, St. Louis, MO (US)

(21) Appl. No.: 18/933,434

(22) Filed: Oct. 31, 2024

Related U.S. Application Data
(60) Provisional application No. 63/594,731, filed on Oct. 31, 2023.

(51) Int. Cl. A47C 7/74; H05B 1/02; H05B 3/34

(52) U.S. Cl. CPC A47C 7/748; H05B 1/0272; H05B 3/34

(57) ABSTRACT

A modular, portable, padded energy-saving seat warmer is described, which enables users to selectively heat seating in a variety of indoor and outdoor environments. The ease of use and robust material composition enable the seat warmer to be easily transported and deployed. Additionally, the modular nature of its design enables the seat warmer to be energy-saving.

### CROSS-REFERENCE TO RELATED APPLICATIONS

This application claims the benefit of Provisional Patent Application Ser. No. 63/594,731, which was filed on Oct. 31, 2023.

### FIELD

The present teachings relate to portable modular seats, warming devices, and seat accessories.

### BACKGROUND

The statements in this section merely provide background information related to the present disclosure and cannot constitute prior art.

Convenient, comfortable seat warming is a broadly recognized need that has nevertheless been insufficiently met. This need is particularly apparent in athletics and other forms of outdoor recreation, which frequently correspond to seasons, and can extend well into the colder months. Whether expected or unanticipated, such recreation often requires both participants and spectators to endure sitting on cold, rigid, plastic, metal, or wooden benches or seats. The short-term discomfort of such seating is obvious, but the long-term effects are arguably more deleterious: prolonged cold exposure increases the risk of injury from recreation, as cold muscles are more prone to strains and pulls, and the psychological effects of discomfort dissuade people from continuing to participate in or support what are otherwise salubrious forms of exercise and recreation.

Providing adequate warming and comfort for seating can seem, at first blush, to be a simple task, but the difficulties are in the details. Seating for outdoor recreation is still only rarely made comfortable due to the failures of prior seat warmer designs in attending to important details. For example, adequate seat warmers need to be resilient to water and weathering in order to survive repeated outdoor use; they need to be portable, as existing recreation facilities cannot be relied upon to supply permanent seat warming installations; they need to be adaptable to a wide variety of seat designs, as there is no single uniform seat configuration in need of warming; finally, they need to be modular, in order to control the area of seating warmed and thereby limiting energy expenditure to what is desired while still being able to accommodate a plurality of users, perhaps with different temperature ideals.

### BRIEF SUMMARY

In various embodiments, presented herein is a modular, portable, energy-saving seat warmer. In various embodiments, the seat warmer comprises an outer weather-resistant layer either fully or partially surrounding an inner cushioning layer, within which are also one or more heating elements positioned to increase the surface temperature of at least one of the warmers exterior-facing surfaces. The heating elements are operably connected to a power supply and an optional heating controller. Straps and securements enable a user to fit the seat warmer securely to seats of various designs.

In various embodiments, the seat warmer described herein further comprises connection means for securing adjacent seat warmers to one another. The modularity inherent in connectable seat warmers enables higher energy efficiency, more robust operating conditions, and the ability to conserve energy usage by only heating those areas of a seat that are likely to be used.

The modularity serves the ancillary function of accommodating multiple users at a time, thereby supporting a spirit of teamwork while simultaneously providing an environment that would decrease the likelihood of muscle pulls, strains, or tears due to exertion enacted on muscle groups that are not sufficiently warm to stay loose and flexible.

In various embodiments, the design described herein has the overall flexibility to allow the seat warmer to contort inward on itself for ease of transportation, incorporating connectors permitting the device to become secured to itself for ease of storage and transport.

In various embodiments, the present description also provides a method for providing comfort to a seat by using the seat warmer described herein.

### BRIEF DESCRIPTION OF THE DRAWINGS

FIG. 1 shows a partial side cross-sectional view of an exemplary embodiment of a seat warmer in accordance with the present disclosure.

FIG. 2 shows isometric view of an exemplary embodiment of a seat warmer in accordance with the present disclosure.

FIG. 3A shows a partial top-down cross-sectional view of an exemplary embodiment of a seat warmer, with particular emphasis on the portable energy supplies and electrically resistive heating element. FIG. 3B shows a schematic depiction of the connection between a portable energy supply, a heating controller, and a heating element.

FIG. 4A shows a top-down cross-sectional view of an alternative exemplary embodiment of a seat warmer in accordance with the present disclosure, emphasizing attachment points for additional warming units.

FIG. 4B shows a seat warmer curled in on itself for ease of storage and transportation in accordance with the present disclosure.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what we presently believe is the best mode of carrying out the claimed invention. Additionally, it is to be understood that the claimed invention is not limited in its applications to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

The portable modular energy-saving seat warmer disclosed within comprises, in various exemplary embodiments, a seat to which is attached one or more securements, one or more electrically resistive heating elements, and an energy supply.

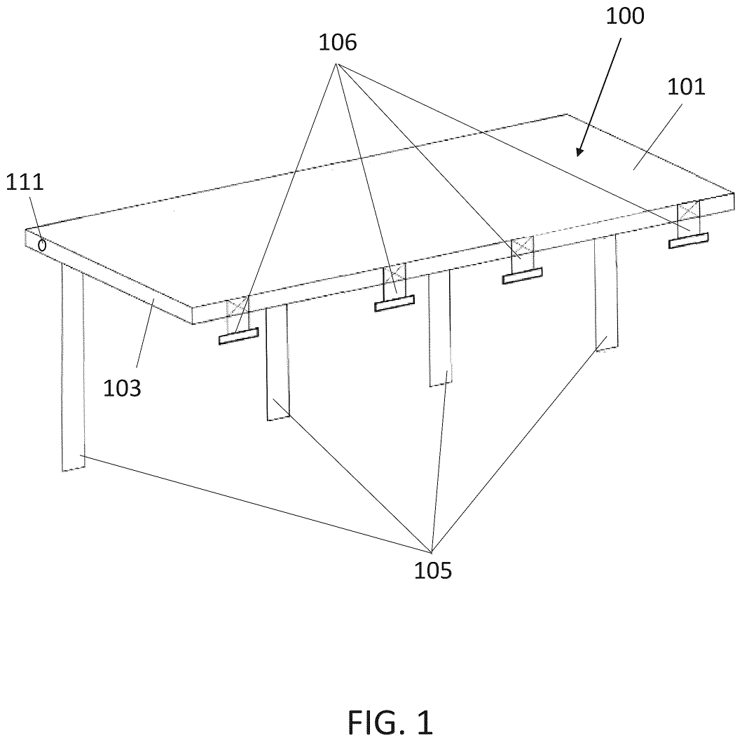

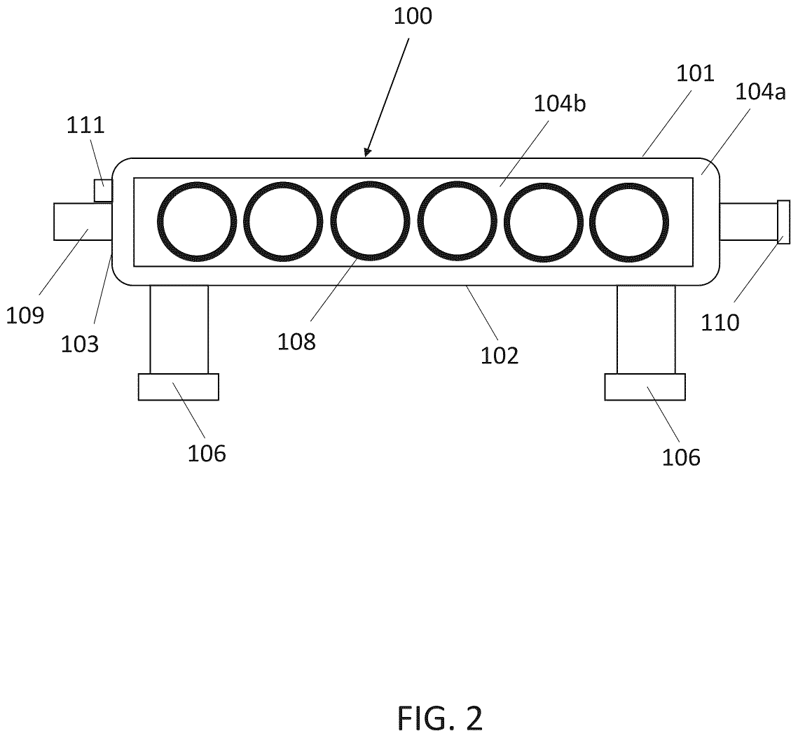

Referring to FIGS. 1 and 2, in at least one embodiment, a seat warmer 100 comprises an outer layer 104a that is atop an inner layer 104b. In various exemplary embodiments, the outer layer 104a can completely surround the inner layer 104b, or it can partially surround it such that some portion of the inner layer is exposed. In various embodiments, the outer layer 104a surrounds a portion of the inner layer 104b, but leaves a portion of an underside of the inner layer exposed. The outer layer 104a further comprises an uppermost surface 101 and a lowermost surface 102, as well as one or more side surfaces 103. The uppermost surface 101 is disposed so as to receive a user's rear end, and the lowermost surface 102 is disposed so as to rest on a bench, chair, ground or other seat or surface for sitting. In various exemplary embodiments, the seat warmer 100 is substantially shaped as a quadrilateral prism, and thus there are four side surfaces 103. In alternative embodiments, the seat warmer 100 may be triangular, thus comprising three side surfaces 103, or circular, thus comprising one side surface 103, or any other shape feasible to one of ordinary skill in the art.

The outer layer 104a can be made of any suitable material known to one of skill in the art to provide comfort for a user. Such materials include but are not limited to common upholsteries such as cotton, linen, polyester, acrylic, olefins, vinyl, leather, faux leather, and other natural and synthetic fabrics or any combination thereof. In various exemplary embodiments, the outer layer 104a can be chosen from materials known to be both comfortable and resistant to moisture and weathering, such as polyamide polymer, thereby being ideal for use in outdoor recreational seating contexts.

The inner layer 104b, which is completely or partially covered by the outer layer 104a, comprises a cushioning material and one or more heating elements 108. The cushioning material can be any material known to one of ordinary skill in the art, including but not limited to polyurethane foam, latex foam, polyester fibers, down, cotton batting, wool, buckwheat hulls, gels, and any other natural or artificial padding materials. In various exemplary embodiments, the cushioning material can be a type of polyurethane foam known as memory foam, thereby providing ideal comfort and support while contouring to the shape of the user.

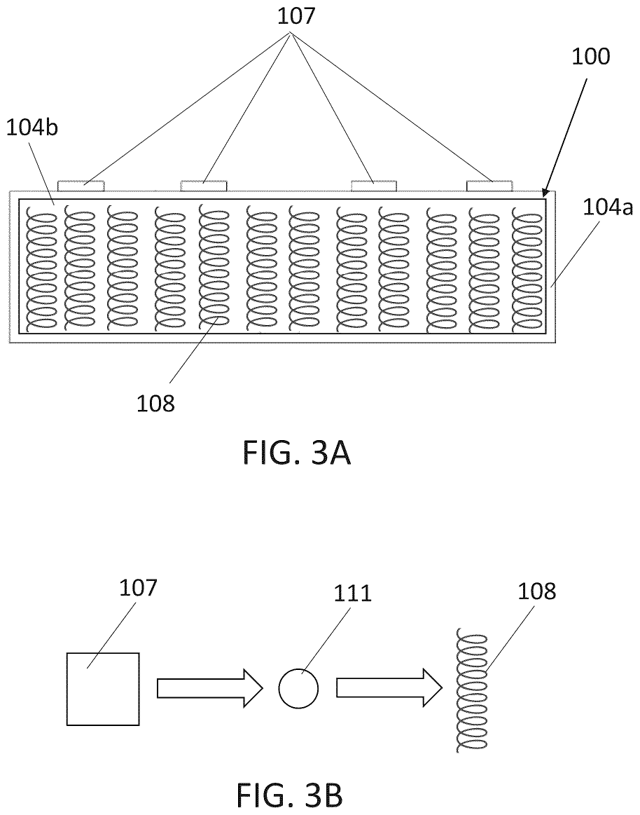

Turning to FIG. 3A, the one or more heating elements are operably connected to one or more power supplies 107, which supply electricity to operate the one or more heating elements. The one or more power supplies 107 can be of any type known to one of ordinary skill in the art, including but not limited to solar cells, fuel cells, single-use batteries, and rechargeable batteries. In various exemplary embodiments, the one or more power supplies 107 can be rechargeable batteries that can be connected to a universal serial bus (USB) port via a USB cable either for recharging or for a constant usable supply of electricity during operation of the seat warmer 100.

The one or more heating elements 108 can, in various exemplary embodiments, be embedded in the cushioning material of the inner layer 104b, or alternately they can be relatively physically isolated via the use of one or a plurality of electrically insulating materials as known to one of ordinary skill in the art. The one or more heating elements 108 can be made of any material known to one of ordinary skill, including metals and their alloys, such as nickel-chromium alloys, iron-chromium-aluminum alloys, nickel-iron alloys, and copper-nickel alloys, as well as non-metal materials such as ceramics and carbon fibers or composites thereof.

In various exemplary embodiments, the one or more heating elements 108 can be of any shape and disposition known to one of ordinary skill in the art for the purpose of gently heating the inner layer 104b and outer layer 104a of the seat warmer 100. In various non-limiting examples, the one or more heating elements 108 can be shaped as coils, straight wires, strips, ribbons, tubes, cartridges, or any of a variety of rigid or conformal arrangements. In FIGS. 2-4A, the one or more heating elements 108 are depicted as coils, but this is only for visual intelligibility and should not be understood as limiting.

The one or more heating elements 108 are intended to gently warm the seat warmer 100 upon the application of a voltage across each of the one or more heating elements. Thus, it is necessary that the heating elements never exceed an output heat flux that would be detrimental to the integrity of the seat warmer 100 or the safety of the user. Additionally, different users are likely to prefer different heat output levels within a range of safe operating parameters for the seat warmer 100. As seen in FIG. 3B, to achieve this, the one or more heating elements 108 can, in various exemplary embodiments, be operably connected to a heating controller 111. The heating controller 111 regulates the output level of the one or more heating elements 108 according to any means known to one of ordinary skill in the art. The heating controller can function according to any means known to one of ordinary skill in the art, including but not limited to voltage control through a variable transformer, pulse width modification, thermostatic control, phase angle control, proportional-integral-derivative control, resistance tuning, and current limitation. In various exemplary embodiments, the level of heating output can be restricted to two or more user settings, such as a ‘high’ heat setting and a ‘low’ heat setting. In various exemplary embodiments, there may instead be three, four, five, or any greater number of such settings.

The seat warmer 100 can be adapted to a variety of seat types. In part, this is accomplished with the use of one or more straps 105 and an equivalent number of one or more securements 106 as seen particularly in FIG. 1. The one or more straps 105 are arranged along the one or more side surfaces 103 such that each of the one or more straps is located in opposition to a corresponding securement 106. After the seat warmer 100 is applied to a seat (not shown) such that the lowermost surface 102 is in contact with the seat, each of the one or more straps 105 can be looped around the underside of the seat and then securely be received and held by the corresponding securement 106.

The one or more straps 105 can, in various exemplary embodiments, be sufficiently strong and flexible materials known to one of ordinary skill in the art, including but not limited to polyamide, polyester, leather, silicone, rubber, canvas, aramid fibers, and polypropylene, as well as any composite of these and similar materials. In various exemplary embodiments, the one or more straps 105 are made from nylon, thus providing ideal flexibility, tensile strength, and resistance to weathering.

The one or more securements 106 can assume any of a number of forms known to one of ordinary skill in the art, including but not limited to buckles, ladder locks, ratchet mechanisms, d-rings, o-rings, hook and loop fasteners, cord locks, tension locks and slip locks. In various exemplary embodiments, the one or more securements 106 may be in the form of a combination of hook and loop fasteners and ladder locks, providing the strength and ease of securement inherent to hook and loop systems while also maintaining the ease of adjustment inherent to ladder locks.

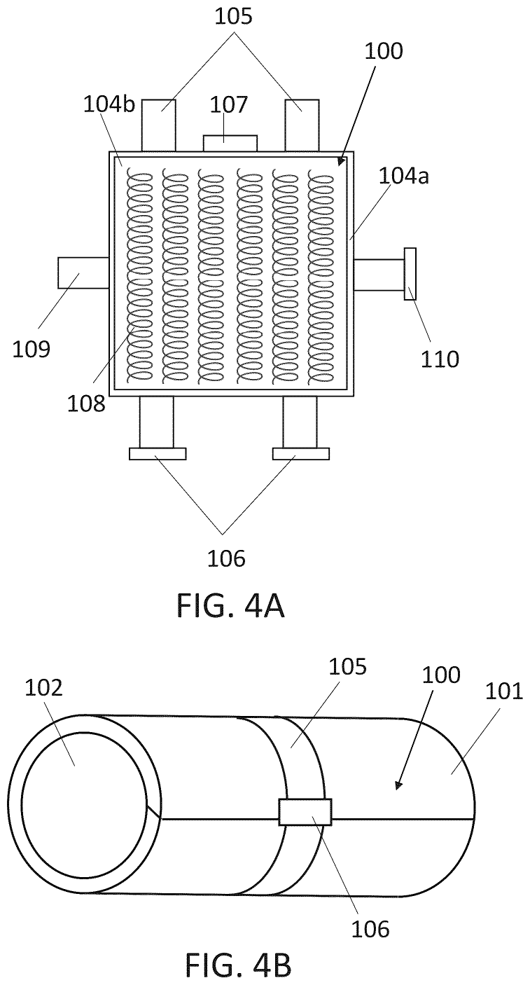

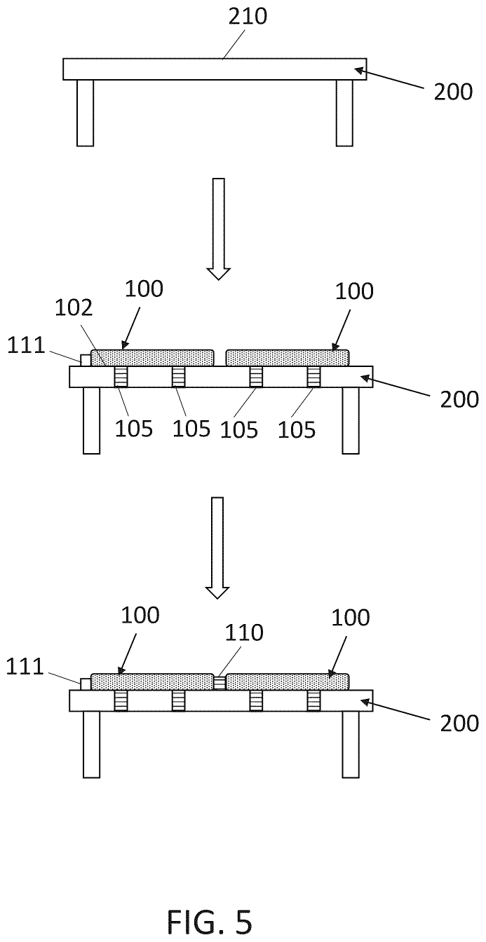

In addition to the portable, adaptable, comfortable, weather-resistant nature of the seat warmer 100 as already described, the seat warmer can in various exemplary embodiments be modular, thereby permitting the connection of multiple seat warmer units in tandem to suit the needs of the user or better accommodate the seat. Multiple units connected in tandem can serve the needs of multiple users with different heating preferences, providing a range or a spectrum of different temperatures to accommodate the varying needs of multiple users. In the alternative exemplary embodiment of FIG. 4A, a substantially square seat warmer 100 is depicted, further comprising a male modular connector 109 and a female modular connector 110. In the even that multiple seat warmers 100 are used, the male modular connector 109 of one seat warmer can operably connect to the female modular connector 110 of an adjacent seat warmer. Thus, multiple seat warmers 100 can be chained together to cover either part or the whole of a seat such as a bench.

In various exemplary embodiments, the male modular connector 109 and the female modular connector 110 connect by means known to one of ordinary skill in the art, including but not limited to by buckles. In various exemplary embodiments, the male modular connector 109 and female modular connector can also electrically connect the respective at least one heating elements 108 of two adjacent seat warmers 100, and thus be connected by any means known to one of ordinary skill in the art, including but not limited to spring clamp terminals and push-in connectors. By electrically connecting the one or more heating elements 108 of multiple adjacent seat warmers 100 via the male modular connector 109 and the female modular connector 110, a user can enable control of an entire connected series of seat warmers via a single heating controller 111. In various alternative embodiments, multiple connected seat warmers 100 can be independently controlled, each by their own individual heating controller 111. Exemplary embodiments of the seat warmer 100 that permit wired connection of multiple adjacent seat warmers enable multiple possible benefits, including but not limited to power sharing to compensate for defunct or undercharged individual battery packs, uniform heat distribution, and the elimination of excess power consumption that might otherwise be used to heat empty seating.

Additionally, in various exemplary embodiments, either a single seat warmer 100 or multiple adjacent, connected seat warmers can be more conveniently arranged for portability and storage by curling them in on themselves. As seen in FIG. 4B, the flexible nature of the materials in the seat warmer 100 in various exemplary embodiments permits the seat warmer to curl in on itself, and then, in this more portable form, be secured by the one or more straps 105 and corresponding one or more securements 106.

In various exemplary embodiments, a method of providing comfort to a seat comprises identifying one or more uncomfortable seats, applying one or more seat warmers, and operating the seat warmers to a user's satisfaction. Turning to FIG. 5, an uncomfortable seat 200 comprising an upper seat surface 210 is identified. One or more seat warmers 100 are applied to the one or more uncomfortable seats 200 such that the lowermost surface 102 is flush with the upper seat surface 210. To secure the seat warmer 100 to the seat 200, the one or more straps 105 are wrapped around the seat and then engage with the one or more securements 106. At this point, a user can activate the one or more heating elements 108, and modulate their output, by use of the heating controller 111.

The uncomfortable seat 200 in one embodiment is a seat of a field bench. A field bench is defined as a bench positioned adjacent and extending along side a playing field exposed to a weather environment. The playing field is a baseball field, a soccer field, a football field or other equivalent type of field located in an open area without a power source such as an electric power source readily available or accessible.

In various embodiments, if multiple adjacent seat warmers 100 are used and the user wishes to connect them, then at least one female modular connector 110 of at least one seat warmer each receives a complementary male modular connector 109 of an adjacent seat warmer. If multiple adjacent seat warmers are so connected, then the user can wait until after connection of the seat warmers to use the heating controller 111 to activate the one or more heating elements 108.

As various changes could be made in the above constructions without departing from the scope of the invention, it is intended that all matter contained in the above description or shown in the accompanying drawings shall be interpreted as illustrative and not in a limiting sense.

What is claimed is:

1. A seat warmer, comprising:
an outer layer comprising an uppermost surface and a lowermost surface in mutual opposition, connected by one or more side surfaces;
an inner layer comprising a cushioning material, such that the outer layer fully or partially surrounds the inner layer;
one or more straps connected to the one or more side surfaces of the outer layer;
one or more securements connected to the one or more side surfaces of the outer layer, such that each of the one or more straps is positioned in opposition to a securement, wherein each of the one or more straps is able to be received and held by a securement;
one or more heating elements distributed throughout the inner layer; and,
one or more power supplies operably connected to the one or more heating elements.

2. The seat warmer of claim 1, further comprising a heating controller operably connected between the one or more power supplies and the one or more heating elements.

3. The seat warmer of claim 2, wherein the heating controller features three selectable heat output settings.

4. The seat warmer of claim 1, wherein the outer layer comprises polyamide.

5. The seat warmer of claim 1, wherein the inner layer comprises memory foam.

6. The seat warmer of claim 1, further comprising one or more male modular connectors affixed to the one or more side surfaces and one or more female modular connectors affixed to the one or more side surfaces, such that the one or more female modular connectors are located in opposition to the one or more male modular connectors, wherein each of the one or more female modular connectors is able to receive and hold one of the one or more male modular connectors.

7. The seat warmer of claim 6, further wherein the one or more male modular connectors and the one or more female modular connectors are operably connected to the one or more heating elements, thereby creating an uninterrupted electrical connection when a female modular connector receives and holds a male modular connector.

8. A method of providing comfortable seating to a plurality of users comprising:
identifying a seat with an upper seat surface;
applying one or more seat warmers each comprising one or more heating elements, a heating controller, and a lowermost surface to the seat such that the lowermost surface of the seat warmer is flush with the upper seat surface; and,
using the heating controller to activate the one or more heating elements.

9. The method of claim 8, wherein the one or more seat warmers each further comprise one or more straps and an equivalent number of securements, further comprising, after the step of applying the one or more seat warmers to the seat, the step of:
securing each seat warmer to the seat by wrapping each securement around the seat and engaging each strap with a corresponding securement.

10. The method of claim 8, wherein the one or more seat warmers each further comprise one or more male modular connectors and one or more female modular connectors, further comprising, after the step of applying the one or more seat warmers to the seat, the step of:
receiving each male modular connector in a corresponding female modular connector.

11. The method of claim 9, wherein the one or more seat warmers each further comprise one or more male modular connectors and one or more female modular connectors, further comprising, after the step of securing each seat warmer to the seat:
receiving each male modular connector in a corresponding female modular connector.

12. The method of claim 8, wherein the seat is a seat of a field bench.
